(19) United States
(12) Patent Application Publication
(10) Pub. No.: US 2007/0266250 A1
(43) Pub. Date: Nov. 15, 2007

(54) Mobile Data Transmission Method and System

(76) Inventors: Werner Kampert, Hamburg (DE); Pavel Knee, Louny (CZ); Wolf-Rudiger Bieber, Wuppertal (DE); Egbert Stamm, Solingen (DE)

Correspondence Address: SCHIFF HARDIN, LLP;PATENT DEPARTMENT, 6600 SEARS TOWER, CHICAGO, IL, 60606-6473, US

(21) Appl. No.: 10/542,960

(22) PCT Filed: Jan. 22, 2004
(86) PCT No.: PCT/EP04/00505

§ 371 Date: Mar. 12, 2007

(30) Foreign Application Priority Data
Jan. 22, 2003 (DE) 103 02 449.2
Oct. 29, 2003 (DE) 103 50 647.0

(51) Int. Cl. H04L 9/00

(52) U.S. Cl. 713/176

(57) ABSTRACT

In a method for transmitting data between a mobile device, in particular a vehicle, and a data center at least temporarily remote from the first device, wherein data transmission takes place via at least one mobile first transmitter device, and comprises the transmitted data, are authenticated by a cryptographic technique.

### BACKGROUND OF THE INVENTION

1. Field of the Invention This invention relates to a method for transmitting data between a mobile first device, in particular a vehicle, and a data center at least temporarily remote from the first device, wherein data transmission takes place via at least one mobile first transmitter device. It further relates to a corresponding arrangement for transmitting data.

2. Description of the Prior Art

Such a generic method is known from the field of railway traffic engineering. A corresponding transceiver unit of the train exchanges data between the train control computer connected thereto and an external traffic control station. If the exchanged data are security relevant data, correspondingly redundant transmission protocols ensure error-free transmission of signals representing the data, or only those signals are accepted whose error probability lies within specific tolerance limits.

One disadvantage to these known methods is that the data represented by the signals are generally not secured against manipulations. Therefore, data transmission between the vehicle and the data center might easily result in deliberate and willful manipulations. This is disadvantageous in particular when these data comprise security relevant first data. To preclude manipulations here, it would be desirable to provide corresponding safeguards for such security relevant first data, thereby protecting against manipulation.

In addition, it would be desirable if the known method could also be used in other areas. In particular, it would be desirable to use such a method when monitoring other mobile devices. This especially includes the monitoring of rented or leased vehicles. However, the problem here once again is that the transmitted data, precisely when they encompass accounting-relevant, and hence security-relevant, first data, for example, with known data transmission processes, are comparatively vulnerable to manipulations.

### SUMMARY OF THE INVENTION

An object of the present invention is to provide a method and a device of the type initially described that exhibit the specified disadvantages at least to a lesser extent, if at all, and that ensure an elevated protection of security relevant data against manipulation, in particular during transmission.

The above object is achieved in accordance with the present invention by a method and system for transmitting data between a mobile device and a data center that is remote from the mobile device, wherein cryptographically authenticated data are generated at the mobile device, and the cryptographically authenticated data are transmitted from a transmitter device at the mobile device.

This invention is based on the premise that an elevated protection of security relevant data against manipulation is achieved by authentication of the transmitted data by cryptographic means. The advantage to authentication is that by a corresponding verification process, it can be proved without doubt that the data were not manipulated during transmission or even at a later point.

Authentication by cryptographic means can take place in an arbitrary known manner. For example, a so-called message authentication code (MAC) can be used. Such an MAC is usually generated using a so-called shared secret, gene rally a secret key, known to both the MAC-generating unit and the MAC-verifying unit, but otherwise kept secret. The data to be authenticated are passed along with the secret key to a calculating algorithm, which generates an MAC from this. The calculating algorithm is designed in such a way that, without knowledge of the secret key, the MAC cannot be reconstructed from the data to be authenticated without an excessively high computing outlay. The calculating algorithm usually includes a so-called hash algorithm (e.g., SHA-1, SHA-2, MD5, etc.). In order to verify the MAC, the verifying unit uses the data to be authenticated along with the secret key to generate a second MAC with the same calculating algorithm, which is then compared with the MAC assigned to the data to be authenticated. If they match, the data are authentic.

Given the easier management of used cryptographic keys, in particular the easier distribution of public keys, e.g., with in the framework of a so-called public key infrastructure (PKI), digital signatures are preferably used to authenticate the data. In this case, the unit generating the digital signature encrypts the data to be authenticated or a value generated therefrom with a private key, which is generally known only to it. In order to verify the signature allocated to the data to be authenticated, and hence check data authenticity, the verifying unit decrypts the signature with a public key known to it, which is allocated to the private key. The decryption result is then compared with the data to be authenticated or a value generated from it according to the algorithm used during encryption. If they match, the data are authentic.

The data to be authenticated can basically involve any kind of data. Therefore, this can include arbitrary data acquired or generated by the components of the device or of the data center. In particular, this can relate to arbitrary data acquired by corresponding acquisition devices of the mobile first device. Among others, these include measuring data measured with arbitrary measuring devices.

The authentication of data preferably also involves authenticating of their respective source. To this end, preferably the data for authentication encompass at least one source identification. This source identification is preferably ambiguously assigned to the source. Preferably, it is a unique unambiguous identification. The source identified via the source identification, can be the device that acquired or generated the data. For example, the source can be a measuring device or a sensor that generates the data. Similarly, the source can be a device that relays the data as the process continues. This makes sense in particular if this device processes, modifies, or otherwise handles the data. For example, the source can be device in which the data are authenticated. The source can also involve a device used to transmit the first data.

Another advantage of this embodiment is that the clear allocation of data to the respective first source based on the authenticated data can later be used to arrive at a conclusion as to the quality and performance of the source. This holds true especially when a longer series of corresponding authenticated data is available, so that a corresponding history can be compiled for the performance of the source, and used to draw appropriate conclusions.

The source can be a component of the device, the transmission device, the data center or any other device used in the data transmission. The data preferably each encompass a source identification for all stations traversed by the data during transmission, thereby enabling a seamless reconstruction of their transmission path at a later time.

In particularly advantageous embodiments of the method according to the invention, the receiver of the data is also authenticated. This makes it possible to subsequently verify which data were transferred to a specific receiver. This is important especially in cases where receipt of the data represents satisfaction of a specific, paid service. Authenticating the receiver according to the invention then makes it possible to advantageously verify the receiver of the data, and hence the service, at a later time. To this end, the invention advantageously provides that the data, for authenticating a receiver of the data, encompass a receiver identification.

Depending on the transmitter device, the receiver can be a component of the device, the transmitter device, the data center or any other device used via which data transmission is effected. As with the source identification described above, preferably the data include a receiver identification for each receiver involved in the transmission. Given intermediate stations during the transmission, the receiver identification then generally corresponds to the source identification, so that only a single identification must be integrated into the data for such intermediate stations.

In particularly advantageous variants of the method according to the invention, the transmission itself or a feature of this transmission is additionally authenticated. This makes it possible to identify not just the data and participating communicating partners without any doubt at a later point. It also makes it possible to identify the transmission process itself and/or assess its quality. For example, the transmission can be integrated into a series of transmissions using a corresponding time feature in order to generate a history of the transmissions and the transmitted data, respectively. In like manner, transmission quality can be evaluated later based on a corresponding quality feature, e.g., the signal-to-noise ratio, the number of connection attempts, type and/or number of errors encountered, etc. To this end, the invention provides that the data for authenticating the first data transmission include a transmission identification. This transmission identification can include a consecutive transmission number, for example, which clearly identifies the transmission, e.g., along with the identification of the communicating parties. An exact chronological categorization of the transmission is possible if the transmission identification includes absolute time data relating to the beginning and/or end of transmission.

In other preferred embodiments of the method according to the invention, temporal events are authenticated. According to the invention, to this end, the data include at least one time code characteristic for a specifiable event. The specifiable event can be the generation or acquisition of the data to be transmitted, for example, or the transmission or the reception of the first data, respectively. A respective time code is preferably provided for each one of these processes. In other words, the data include a first time code, for example, which is representative for the time at which the data to be transmitted were generated or acquired, a second time code, which is representative for the transmission of these data, and a third time code, which is representative for the reception of these data.

Particularly advantageous variants of the method according to the invention provide that the authenticated data be incorporated into a protocol data set, which is stored in the first device, and additionally or alternatively in the data center. This protocol data set makes it possible for both communicating parties to easily verify the correspondingly authenticated data at whatever later time desired, if necessary.

Particularly favorable variants of the method according to the invention are characterized in that they enable a reliable monitoring of specific states, in particular specific states of the mobile first device. To this end, the invention provides that the data include monitoring data transmitted from the device to the data center, which include at least one first acquisition value for an acquisition variable determined by an acquisition device of the device.

The acquisition variable can essentially involve any variable determined by corresponding acquisition devices. For example, it can be a state variable for the environment of the mobile device, which is determined by corresponding sensors or the like of the mobile device. However, the method according to the invention can be used in an especially advantageous manner to monitor the state of the mobile device itself. Therefore, the acquisition variable advantageously is a state variable of the device. This state variable can be an operating parameter of the device, for example. These include the speed and acceleration of the device, which can be determined by amount and direction. It can also involve temperature, e.g., the temperature in the circulating cooling water or engine oil, etc. Finally, it can involve oil level, tire pressure or any other state parameter. Otherwise, it is understood that any combinations of such acquisition variables can be determined via corresponding acquisition devices and transmitted in order to characterize the state of the device.

Other embodiments of the method according to the invention make it possible to influence certain operating parameters, and hence the operation of the mobile first device. To this end, the data encompass at least operation-influencing data that are transmitted to the device to influence the operation of the device. For example, this makes it possible to vary the current operating parameters by transmitting the data to the device. In like manner, for example, parts of the operating software of the device can be exchanged, or the operating software can even be completely exchanged. Authentication of the data according to the invention, if necessary in conjunction with other security mechanisms, ensures that only authentic and authorized data are taken into account. In other words, only an authorized influencing of mobile first device operation is hence possible.

In other embodiments of the method according to the invention, the data are transmitted via at least a second data transmitter device. This second data transmitter device can also be either, mobile or stationary. This makes it possible to realize a cost-effective transmission system. In this way, the second data transmitter device can be designed with sufficient capacity to transmit the first data over a long path to and from the data center. The first data transmitter device can then be made simpler and more cost-effective in design. In particular, it can be designed for a shorter transmission path to the second data transmitter device. In such a system, for example, a network of second data transmitter devices covering a sufficient area can be realized, wherein a first data transmitter device and a second data transmitter device need only to come close enough to each other to ensure transmission between the mobile first device and the remote data center.

This invention also relates to a method for monitoring a mobile device, in particular a vehicle, in which, via a mobile data transmitter device, data are transmitted between the mobile device and a data center at least temporarily remote from the device using the method according to the invention described above. According to the invention, the data include monitoring data transmitted from the device to the data center. The monitoring data include at least an acquisition value of an acquisition variable, which was determined by an acquisition device of the device. These monitoring data are verified in the data center. Finally, given a successful verification, the monitoring data are analyzed in the data center.

A monitoring response preferably is initiated in the data center as a function of the analysis performed on the monitoring data. The monitoring response can essentially involve any response.

In embodiments of the method according to the invention, the monitoring response can be an invoicing process. For example, when monitoring the utilization of rented or leased mobile units, e.g., motor vehicles, construction equipment, etc., utilization can be invoiced as a function of the invoicing-relevant utilization that was determined by corresponding acquisition devices, transmitted and analyzed. The authentication of transmitted data according to the invention here ensures that these data were not manipulated during transmission. To this end, in accordance with the invention the monitoring response includes an invoicing step.

Additionally or alternatively, any other monitoring responses desired can be initiated. In this way, so-called early warning systems can be realized within the framework of monitoring the operating state of mobile devices. For example, if errors or critical states of certain units in the device are detected via the first data, or an analysis of the data shows that, eventually with a specific probability, such errors or critical states arise within a specific period of time, a corresponding message can be transmitted to the device as a monitoring response. The device can then output this message to the current user via a corresponding interface, e.g., visually and/or acoustically. Of course, this message can be transmitted correspondingly authenticated in the manner described above in order to preclude manipulations. Additionally or alternatively, such a message can be transmitted from the data center automatically, e.g., via mobile radio, to a correspondingly registered user.

Naturally, not only acquisition variables directly relevant in terms of the function of the mobile unit can be determined but also other acquisition variables having no direct influence on the functional capacity of the mobile unit can be determined.

For example, in the case of rented or leased mobile units, the current utilization can be monitored, and a corresponding message can be generated as a monitoring response as soon as the user has exceeded or is about to exceed the agreed framework of use. In like manner, a switch can be made to another invoicing mode as a monitoring response if the agreed utilization framework has been exceeded. For example, if a specific kilometer output was reimbursed in a lump sum, a switch can be made to a kilometer-based invoicing of the extra kilometers if this kilometer output was found to have been exceeded.

In like manner, for example, the position can be monitored and analyzed as the acquisition variable for rented or leased motor vehicles or machinery. If the user violates an agreement, or such a violation is imminent, a corresponding message or warning can be transmitted as a monitoring response.

In addition, the operating duration can be monitored based on corresponding criteria, for example, while monitoring prescribed rest times for drivers. If one or several acquisition variables indicate that the prescribed rest times are not being observed or will likely be violated, a corresponding message or warning can also be sent as the monitoring response.

Countermeasures could be introduced in the two above cases under specific conditions as another monitoring response. In the simplest case, this can be accomplished by correspondingly informing a sovereign entity, e.g., the police or the like, to terminate the violation.

In like manner, however, under observance of corresponding security regulations, the first device can be directly influenced as a monitoring response. If needed, this can extend all the way to the controlled shutdown of the device.

Naturally, this type of influence can also be exerted during the aforementioned monitoring of functionally relevant acquisition variables. Therefore, it is preferably provided that the monitoring response includes the generation of operation influencing data, which are transmitted to the device to influence the operation of the device. For example, if it is determined that a critical state relative to a specific operating parameter is imminent or in place, under observance of corresponding security regulations, corresponding countermeasures can be introduced to avert or eliminate this critical state. Among other things, it is here possible to service or even completely replace damaged operating software or parts by such an operation influencing.

In all aforementioned cases with corresponding monitoring responses, authentication of the first data transmitted to the mobile unit within the framework of the monitoring response ensures that no unauthorized manipulations can take place within the framework of such a monitoring response, but rather that only processes based on correspondingly authorized data are run.

In other embodiments of the method according to the invention, additional data not transmitted from the device can be taken into account during the analysis. For example, these data can involve statistical data obtained by evaluating the data stemming from structurally identical or similar first devices. In like manner, however, these can be data transmitted to the data center by other means. In particular, external information regarding the first device can be taken into account when triggering a monitoring response. For example, one of the monitoring responses described above can be initiated if the data center receives information that the device has been stolen or the like.

This invention also relates to an arrangement for transmitting data between a mobile device, in particular a vehicle, and a data center at least temporarily remote from the device, wherein at least one mobile first transmitter device is provided for transmitting the data. According to the invention, the transmitted data comprise data, and at least one security device is provided, designed to generate a data set representing the data, and to authenticate the data via cryptographic means. The arrangement according to the invention is suitable for executing the method according to the invention. It can be used to realize the embodiments and advantages described above in the same manner, such that reference is made to the above statements in this regard.

The security device here encompasses a cryptography module, which provides the cryptographic means described above. The security device can here be designed in particular for generating a MAC as described above. The security device is preferably designed to generate a digital signature using the data, in order to authenticate the data.

The cryptography module can be used both, for encoding data to be stored as well as for encoding data to be transmitted. Of course, various cryptographic processes can be used depending on application, e.g., depending on whether data are to be transmitted or stored.

In addition to the cryptographic algorithms and one or more corresponding cryptographic keys, the cryptographic data of the cryptography module preferably comprise additional data, e.g., one or more cryptographic certificates of corresponding certification instances and, if needed, one or more separate cryptographic certificates of the security device.

The security device preferably is designed for exchanging at least a portion of the cryptographic data, so as to advantageously ensure easy and long-term reliable data security. In this case, it can be provided in particular that the respectively used cryptographic algorithm can be exchanged in addition to the cryptographic keys and cryptographic certificates, so that the system can be easily adjusted to altered security requirements. The implementation and exchange of cryptographic data preferably take place within the framework of a so-called public key infrastructure (PKI), which is sufficiently well known, and hence need not be described in any greater detail at this juncture. It is understood in particular that a corresponding routine for verifying the validity of the used cryptographic certificates is provided. Suitable verification routines of this kind are also sufficiently well known, and hence need not be described in any more detail here.

The security device preferably is designed for authenticating a source of the data as described above. To this end, the security device is preferably designed for incorporating a source identification in the data set. In addition, the security device is preferably designed for authenticating a first receiver of the data as described above. To this end, it is preferably designed for incorporating a receiver identification in the data set.

In preferred embodiments of the arrangement according to the invention, the security device is designed for authenticating the transmission of data. To this end, it is preferably designed for incorporating a transmission identification in the data set. In addition, the security device is preferably designed for incorporating at least one time code characteristic for a specifiable event in the data set.

In other embodiments of the arrangement according to the invention, it is provided that the security device is designed for incorporating the authenticated data into a protocol data set. The device then has a protocol memory for storing the protocol data set. Additionally or alternatively, the data center has another protocol memory for storing the protocol data set.

The security device can basically be arranged at any location in the transmission path. The first device preferably has such a security device. Additionally or alternatively, the data center encompasses a further such security device.

In embodiments of the arrangement according to the invention, the data of the device include monitoring data transmitted to the data center. In turn, these monitoring data comprise at least one acquisition value for an acquisition variable. The device additionally includes an acquisition device for acquiring the first acquisition value. As mentioned above, the acquisition variables can include any measurable variables. The acquisition device preferably is designed for determining a state variable of the device as the acquisition variable.

In additional embodiments of the arrangement according to the invention, the data include operation influencing data transmitted from the data center to the device. The first device then has an operation influencing device, so as to influence the operation of the device as a function of the operation influencing data, as described above in conjunction with the method according to the invention.

This invention also relates to an arrangement for monitoring a mobile device, in particular a vehicle, with an arrangement according to the invention for transmitting data. The data here encompass monitoring data transmitted from the device to the data center, which include at least one first acquisition value of an acquisition variable. The device also includes an acquisition device for determining the acquisition value. The data center has a second security device for verifying the first monitoring data. In addition, the data center has an analyzer device connected with the second security device for analyzing the first monitoring data as a function of the verification result. This arrangement according to the invention is suitable for executing the method according to the invention for monitoring a mobile first device. It can be used to realize the embodiments and advantages described above in the same way, such that reference is made to the above statements in this regard.

At least one monitoring response device that can be connected with the analyzer device preferably is provided for executing a monitoring response. The analyzer device is then designed to trigger the monitoring response device in order to initiate a monitoring response as a function of the result from analyzing the monitoring data.

An invoicing device that can be connected with the analyzer device is preferably provided as a monitoring response device. In addition, the monitoring response device preferably is designed for generating operation influencing data as the monitoring response, wherein operation influencing data are used to influence the operation of the device. The data center is then designed for transmitting data to the device, wherein the data comprise the operation influencing data. Finally, the device has an operation influencing device for influencing the operation of the device as a function of the operation influencing data.

In another preferred variant of the arrangement according to the invention, the device includes a security device that is designed to verify the data comprising the operation influencing data. The operation influencing device is then designed for influencing the operation of the device as a function of the verification result.

This invention also relates to a mobile first device, in particular a vehicle, for an arrangement according to the invention. According to the invention, the device includes a data transmitter device for transmitting data, and a security device that can be connected with the data transmitter device. The security device is designed for generating a data set representing the data, and for authenticating the data by cryptographic means.

In a preferred embodiment of the mobile device according to the invention, the security device is designed for authenticating the data transmitter device. To this end, it preferably is designed for incorporating an identification allocated to the data transmitter device in the data set.

Finally, this invention relates to a data center for an arrangement according to the invention. According to the invention, the data center has a data transmitter device for transmitting first data, and a second security device that can be connected with the data transmitter device, and is designed for generating a first data set representing the first data, and for authenticating the first data by cryptographic means.

In order to enhance protection against undetected, unauthorized manipulation of the stored data, in particular the stored acquisition values, the respective security device preferably is designed for checking access authorization to at least a part of the security device or other parts of the device or the data center. The check can here be limited to individual, correspondingly security-relevant areas of the security device. However, it can also extend to a check of the access authorization for all areas of the security device.

The access authorization to the memory where the data are stored is preferably already checked to prevent unauthorized access to the data. However, it is understood that access to the memory for the data can be permitted in specific variants of the arrangement according to the invention even without special access authorization if the data have already been stored in a correspondingly authenticated manner, so that unauthorized manipulations to the data are detectable. This is the case if the data have already been stored together with authentication information generated with the use of the data, e.g., an aforementioned MAC, a digital signature or the like. The authentication information then preferably, is generated in an area of the security device for which access authorization is checked, provided such access is even possible.

As a result, unauthorized manipulation of the stored data is either not possible at all for lack of access to the data, or at least does not pass undetected during a check.

The access authorization can basically be checked in any suitable manner. For example, it is possible to implement a password system or the like. It is preferably provided that the processing unit be designed for checking access authorization using cryptographic means. In this case, for example, digital signatures and cryptographic certificates can be used. This is particularly advantageous, since such cryptographic processes ensure a particularly high security standard.

In this case, at least two different access authorization levels can be provided, which are linked with varying access rights to the security device and devices connected thereto, respectively. This makes it possible to easily implement a hierarchical structure with access rights differing in scope. For example, a user of the arrangement can be allowed to read out the stored first data at the lowest access authorization level as the sole access action, while an administrator, in addition to reading out the data, can modify additional components of the security device, etc., on a higher access authorization level.

On the other hand, the access authorization levels make it possible to control access to different areas of the security device or devices connected thereto on the same hierarchy level. The number of access authorization levels or classes here depends on the respective use of the arrangement, and the complexity of applications realizable with the arrangement according to the invention.

In preferred embodiments of the arrangement according to the invention, the acquisition values are linked with a acquisition time code characteristic for the acquisition time of the acquisition value. Frequently also referred to as a time stamp, this linkage of the stored acquisition value with the time of its acquisition tangibly simplifies further processing of the acquisition value, e.g., for purposes of invoicing, or for purposes of statistics, etc. This holds true in particular when several acquisition values determined at different times are to be processed.

However, it is understood that it may be sufficient in other embodiments of the invention without such time stamps to just implement suitable measures making it possible to reproduce the chronology of acquisition for the acquisition values. For example, the acquisition values can be allotted consecutive numbers to achieve this goal.

The acquisition time can be determined in any suitable manner. The security device for determining the acquisition time code preferably comprises a time acquisition module connected with the processing unit. This can involve an integrated real-time clock or a module that scans the real time via a suitable communication link to a corresponding instance. The integrated real-time clock can here be synchronized with a correspondingly accurate time source from time to time, as needed.

In a preferred embodiment of the invention, at least one second acquisition device for determining at least one second acquisition value of the first acquisition variable is provided. This make it possible to operate even larger systems with several acquisition locations of the acquisition variable, e.g., several measuring points for the consumption of a consumer good, with a reduced number of security devices, if necessary even with a single security device. In order to ensure separation of the first and second acquisition values, the first and second acquisition values are filed in different memory areas. In particular, varying access authorizations can here be defined for the different memory areas to ensure that only the respectively authorized persons or devices can access the corresponding memory area.

However, it is especially advantageous to store the first acquisition value linked with a first acquisition device code characteristic for the first acquisition device, and the second acquisition value linked with a second acquisition device code characteristic for the second acquisition device. This clear allocation between the acquisition device and the acquisition value that it acquires enable a particularly simple and reliable separation, which greatly facilitates further processing later on.

In other embodiments of the arrangement according to the invention, the first acquisition device is designed for determining at least a third acquisition value of a second acquisition variable. As an alternative, a third acquisition device for determining at least one third acquisition value of a second acquisition variable can be provided. This makes it possible to realize the acquisition and secured storage of acquisition values for different acquisition variables using a single security device.

In order to ensure separation of the first and third acquisition values, it can here once again be provided that the first and third acquisition values are stored in different memory areas. However, it is especially advantageous here as well to store the first acquisition value linked with a first acquisition variable code characteristic for the first acquisition variable, and the third acquisition value linked with a second acquisition variable code characteristic for the second acquisition variable. This clear allocation between the acquisition device and the acquisition variable that it acquires enables a particularly simple and reliable separation, which greatly facilitates further processing of the stored data later on.

In preferred embodiments of the arrangement according to the invention, the acquisition device and security device are arranged in a secure environment protected against unauthorized access, in order to effectively preclude in an advantageous manner unauthorized access not just to the data of the security device, but also to the data supplied from and to the acquisition device.

The secure environment can here be physically established using one or more correspondingly secure housings. These housings are then preferably equipped with corresponding, sufficiently known means for detecting manipulations to the casing. However, protection is also provided logically by a correspondingly secured communication protocol between the first acquisition device and the security device. For example, a secured communication channel is established for each communication between the acquisition device and the security device via a correspondingly strong mutual authentication. It is understood that the first acquisition device has corresponding communication means in this case, which provide the described security functionality.

It is further understood that the secure environment can be extended to a space of any size by such logical securing mechanisms. The acquisition device and the security device in such designs can be arranged within the secure environment spaced widely apart. It is also understood that the secure environment can also be expanded to other components, e.g., the data center, using such logical securing mechanisms.

It is understood that all of the above-described modules and functions of the security device can be realized by means of correspondingly designed hardware modules. However, they are preferably designed at least in part as software modules, which the processing unit accesses to realize the corresponding function. It is further understood that the individual memories do not have to be realized by separate memory modules. Rather, these are preferably corresponding logically separated memory areas of a single memory, e.g., a single memory module.

### DESCRIPTION OF THE DRAWINGS

FIG. 1 schematically illustrates a preferred embodiment of the system according to the present invention, operable for implementing the method according to the present invention.

FIG. 2 is a block diagram showing basic components of the system of FIG. 1.

FIG. 3 schematically illustrates another preferred embodiment of the system according to the present invention.

FIG. 4 schematically illustrates another preferred embodiment of the system according to the present invention.

### DESCRIPTION OF THE PREFERRED EMBODIMENTS

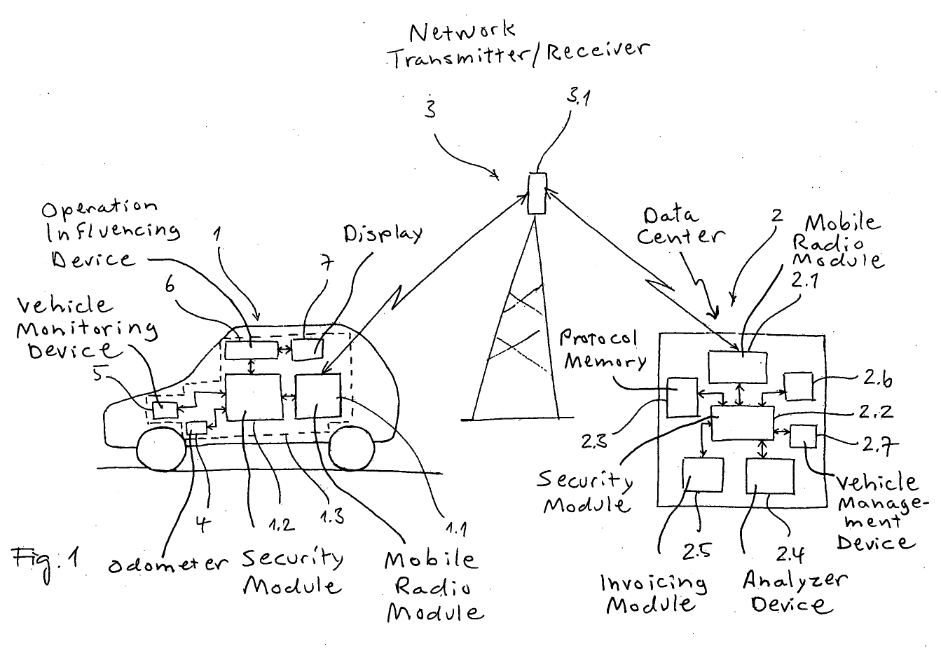

FIG. 1 shows a preferred embodiment of the arrangement according to the invention for transmitting data between a mobile first device in the form of a vehicle 1 and a data center 2 located a distance away from it. The vehicle 1 is a rental car in this instance. This invention is here used in conjunction with monitoring and particularly invoicing for the utilization of this rental car.

The motor vehicle 1 has a mobile first transmitter device in the form of a mobile radio module 1.1 for a mobile radio network 3. The mobile radio module 1.1 can be used to exchange data via a transmitter/receiver device 3.1 of the mobile radio network 3 with a third transmitter device in the form of a second mobile radio module 2.1 of the data center 2.

The motor vehicle 1 also has a first security device in the form of a first security module 1.2 connected with the first mobile radio module 1.1. At the latest when security-relevant data are to be transmitted via the mobile radio network 3 from the motor vehicle 1 to the data center 2, the first security module 1.2 generates a first data set representing first data, which encompasses the security-relevant data to be transmitted, among other things. The first security module 1.2 then authenticates the first data using cryptographic means.

To this end, the first security module 1.2 allocates authentication information to the first data set, by first using a corresponding cryptographic algorithm and a private, first cryptographic key of the security module 1.2 to generate a first digital signature as the authentication information over the first data set. The security module 1.2 then generates a second data set from the first data set and first digital signature.

The first digital signature, i.e., the authentication information, ensures that the first digital signature can be verified at a later point to confirm without a doubt whether the first data set, and hence the first data, were manipulated, or whether authentic data are still present.

In order to enhance security in terms of unauthorized access to the data, the first security module 1.2 encrypts the second data set using a second cryptographic key, wherein a third data set comes about. This third data set is transmitted to the first mobile radio module 1.1 from the first security module 1.2. The first mobile radio module 1.1 then transmits the third data set to the second mobile radio module 2.1 of the data center via the mobile radio network 3.

The second mobile radio module 2.1 transmits the third data set to a second security device connected thereto in the form of a second security module 2.2. The second security module 2.2 then decrypts the third data set using a third cryptographic key, so as to again obtain the second data set in this way. The third key here corresponds to the second key. Involved in this case is a secret session key generated previously for this transmission session. The latter was previously generated separately in the first security module 1.2 and the second security module 2.2. The generation and use of such secret, single-use session keys is known in the art, and will hence not be discussed in any greater detail at this juncture.

However, it goes without saying that another securing mechanism can be selected in other variants of the invention, provided such a securing is required. In particular, the second cryptographic key can be a public key of the second security module when using an asymmetrical encryption. The third key is then the corresponding accompanying private key of the second security module.

The second security module 2.2 extracts the first data set and the first digital signature from the second data set. The second security module 2.2 then uses the first data set and a fourth cryptographic key allocated to the first cryptographic key to verify the first digital signature in a manner known in the art, in order to determine the authenticity of the first data set, and hence the first data.

The same procedure takes place in the other direction if security-relevant data are to be transmitted from the data center 2 to the vehicle 1. In this case, the second security module 2.2 then executes the operations described above for the first security module 1.2, and vice versa.

Within the framework of communication between the vehicle 1 and the data center 2, a strong mutual authentication of the communicating partners takes place using corresponding cryptographic means, wherein in particular corresponding cryptographic certificates are used. This in turn happens using the first security module 1.2 and the second security module 2.2. Since methods for such a strong, mutual authentication of the communicating partners are sufficiently known, this need not be explained in any greater detail.

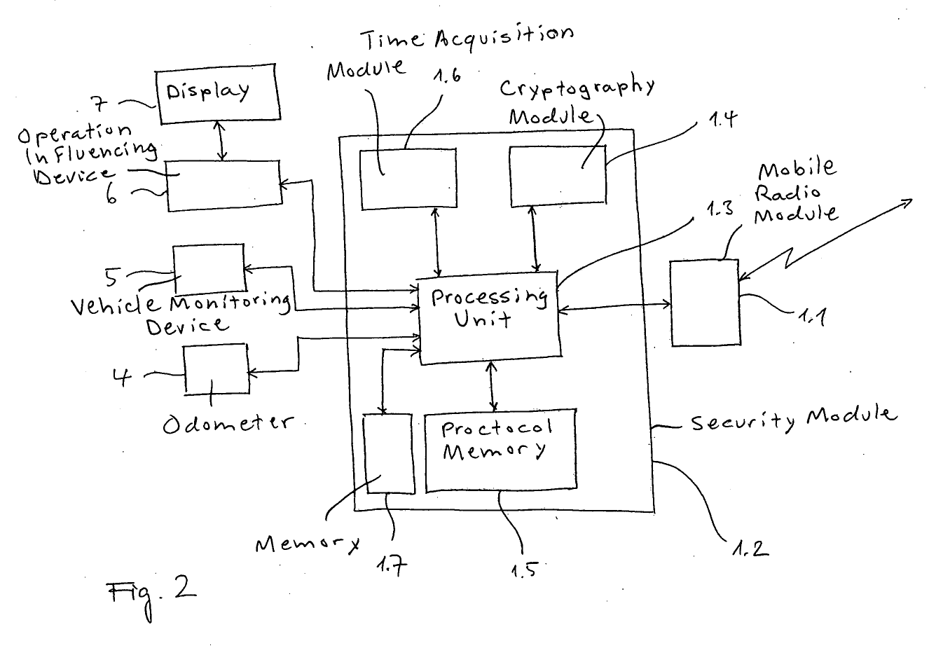

FIG. 2 shows a block diagram of components of the vehicle 1. As evident from this figure, the first security module 1.2 has a first processing unit 1.3, which is connected with the first mobile radio module 1.1. The first processing unit 1.3 is also connected with a cryptography module 1.4, which provides the cryptographic means described above, and contains corresponding cryptographic data for this purpose. Among other things, the cryptographic data comprise cryptographic algorithms and corresponding cryptographic keys. In addition to the cryptographic algorithms and keys, the cryptographic data of the cryptographic module 1.4 include other data, e.g., one or more cryptographic certificates of corresponding certification instances, and if necessary, one or more separate cryptographic certificates of the security device 1.2.

The security module 1.2 is designed for exchanging at least one portion of the cryptographic data, in order to ensure a simple and durably reliable securing of the data. It is here provided that the respectively used cryptographic algorithm can be changed in addition to the cryptographic keys and cryptographic certificates, so that the system can be adjusted to modified security requirements. The implementation and exchange of cryptographic data take place within the framework of a so-called public key infrastructure (PKI), which is sufficiently known, and hence need not be described in any further detail here. In particular, it is understood that a corresponding routine is provided for checking the validity of the used cryptographic certificates. Suitable checking routines like these are also sufficiently well known, and therefore need not be described in any greater detail here.

The cryptography module 1.4 is used both for encrypt data to be stored, and encrypt data to be transmitted. It is understood that different cryptographic processes can be used depending on the application, e.g., depending on whether data are to be transmitted or stored.

After the successful transmission of the third data set, the first security module 1.2 generates a protocol data set, which it stores in a first protocol memory 1.5 connected with the first processing unit 1.3. The protocol data set includes the first data set along with the first digital signature generated over the first data set in the manner described above. In other words, it includes the authenticated first data. The first protocol memory 1.5 can here be designed in such a way that the protocol data set can be read, but not changed. In addition, the first protocol memory 1.5 can be dimensioned in such a way that it can incorporate all protocol data sets to be expected over the life time of the first security module 1.2 or the vehicle 1.

In this example, the protocol data sets are stored in clear text. However, it is understood that the protocol data sets can also be stored in encrypted form in other variants of the invention to protect them from unauthorized viewing.

In the following, the generation of security-relevant first data to be transmitted to the data center 2 will be described with reference to FIG. 1 and 2.

The first data encompass first acquisition values of a first acquisition variable, which were determined with a first acquisition device 4 connected with the first processing unit 1.3. The first acquisition values involve the current values for the kilometer or mileage output of the vehicle 1 as a first acquisition variable. These kilometer values are acquired by the odometer 4 of the vehicle 1 as the first acquisition device, and transmitted to the first processing unit 1.3 at prescribed times, e.g., in regular intervals.

The first processing unit 1.3 links these kilometer values with an acquisition time code characteristic for the time they were acquired, a so-called time stamp, by writing the kilometer value and the acquisition time code in a first kilometer data set. To this end, it accesses a time acquisition module 1.6 of the first security module 1.2, which supplies correspondingly reliable time information. The time acquisition module involves an integrated real-time clock, which is synchronized with a corresponding precise time source from time to time. It is understood that other embodiments of the invention can use a module that scans the real time via a suitable communications link to a corresponding instance.

The first processing unit 1.3 further links the kilometer values with a first acquisition device code characteristic for the odometer 4, by also writing it in the first kilometer data set. Involved here is a unique and unambiguous identification for the respective odometer 4, which simultaneously represents a first source identification for the source of the kilometer values. The first acquisition device code simultaneously represents a first acquisition variable code, since the odometer 4 supplies only kilometer values. It is understood that the respective acquisition values can be linked with a corresponding acquisition variable code if required in other acquisition devices that determine various acquisition variables.

It is understood that the aforementioned linkage of kilometer values with the acquisition time code and the acquisition device code can be secured via cryptographic means. For example, it can be provided that the first security module 1.2 can generate a second digital signature over these data, so that appending the second digital signature to the data links them together, also secured against manipulation. The same naturally can be done for any other data allocated to each other in order to link them in a manner secure against manipulation.

The first kilometer data set generated in this way is then stored by the first processing unit 1.3 in a first memory 1.7 connected with it.

The first data also include second acquisition values of a second acquisition variable and third acquisition values of a third acquisition variable, which were determined by means of a second acquisition device 5 connected with the first processing unit 1.3. The second acquisition values involve the current values of the motor oil level of the motor vehicle 1 as a second acquisition variable. Third acquisition values involve the current values for brake quality of the vehicle 1 as a third acquisition variable. These brake quality values are determined by the vehicle monitoring device 5 of the vehicle 1 as the second acquisition device, and also transmitted to the first processing unit 1.3 at prescribed times, e.g., at regular intervals.

The first processing unit 1.3 links these second and third acquisition values with an acquisition time code characteristic for the time they were determined by writing the motor oil level value, the brake quality value and the acquisition time code in a first vehicle state data set. To this end, it accesses a time acquisition module 1.6 of the first security device 1.2.

The first processing unit 1.3 also links the motor oil level values and brake quality values with a second acquisition device code characteristic for the vehicle monitoring device 5 by also writing them in the first vehicle state data set. Involved here is a unique and unambiguous identification for the respective vehicle monitoring device 5, which simultaneously represents a second source identification for the source of the motor oil level values and brake quality values. In addition, a corresponding acquisition variable code is allocated to the respective acquisition values by also writing it into the vehicle state data set in a correspondingly allocated manner.

The first vehicle state data set generated in this way is then also stored in the first memory 1.7 by the first processing unit 1.3.

At a specific, prescribed or selectable point in time, the kilometer data sets and vehicle state data sets stored in the meantime in the first memory 1.7 are then to be transmitted to the data center 2 as the first monitoring data. To this end, the first processing unit 1.3 reads the stored kilometer data sets and vehicle state data sets from the first memory 1.7, and writes them into the first data set.

The first processing unit 1.3 further adds the first data set by a unique and unambiguous first security module identification allocated to the first security module 1.2, as well as with a first time stamp generated by accessing the first time acquisition module 1.6. The first security module identification here represents a third source identification, while the first time stamp characterizes the time the first monitoring data were compiled. In addition, the first processing unit 1.3 adds the first data set by a unique and unambiguous identification of the first mobile radio module 1.1, which also serves as a source identification.

Finally, the first processing unit 1.3 enhances the first data set with transmission identification in the form of a consecutive transaction number, which is clearly allocated to the running transmission process.

The first data set is subsequently authenticated in the manner described above, and transmitted to the data center 2 in the form of the third data set.

As soon as the data center 2 has verified the authenticity of the first data set, it transmits a corresponding confirmation data set to the vehicle 1. This confirmation data set includes a second security module identification allocated to the second security module. The second security module identification here represents a first receiver identification, which denotes the receiver of the first data set.

The first processing unit 1.3 writes this confirmation data set along with a second time stamp characteristic for the time at which the confirmation data set was received in the existing first data set, and then authenticates the latter again in the manner described above by establishing a digital signature over the first data set. This digital signature is then written along with the first data set in a first protocol data set, which is then incorporated in the first protocol memory 1.5 in the manner described above.

The first protocol data set is subsequently transmitted to the data center 2, where it is first correspondingly checked for authenticity, and then stored in a second protocol memory 2.3 connected with the second security module 2.2. It is understood that the data center 2 in other variants of the invention can also itself generate such a protocol data set, and file it in the second protocol memory.

Therefore, this first protocol data set advantageously authenticates, both, the sources and receivers of the respective data, specific acquisition and processing times, and the transmission itself, so that the facts and circumstances associated with these data can be verified at a later time without a doubt. In particular, it is possible to verify the receipt of the first data in the data center 2.

After the first data have been received in the data center 2 and verified for authenticity, they are transmitted to an analyzer device 2.4 of the data center 2 connected with the security module 2.2. This analyzes the first data transmitted taking into account, among other things, statistical data not originating from the vehicle 1.

As a function of the kilometer values transmitted, the first monitoring response of the analyzer device 2.4 is to initiate a first invoicing process for the traveled kilometers via the invoicing module 2.5 connected with the second security module 2.2 as a first monitoring response device.

As a second monitoring response as a function of the analysis of the first data, the analyzer device 2.4 initiates the generation of operation influencing data for the vehicle 1 by a second monitoring response device 2.6 connected with the second security module 2.2. These operation influencing data are transmitted to the motor vehicle 1 by the data center 2 via the mobile radio network 3 in another first data set. Since the process is here similar to the transmission of the first data from the vehicle 1 to the data center 2, reference is made to the above statements in this regard. In particular, the first data are authenticated in a similar manner, and a corresponding protocol data set is generated for the transmission, and stored in both, the motor vehicle 1 and the data center 2.

As a function of the transmitted kilometer values, the operation influencing parameters include an indication of the currently traveled kilometers, the currently associated charge and the current invoiced amount. After the operation influencing data have been verified for authenticity in the first security module 1.2, this information is transmitted to an operation influencing device 6 connected with the first security module 1.2, which in turn outputs them to the user of the vehicle 1 on a connected display 7. Depending on the analysis of the transmitted vehicle monitoring data (motor oil level and brake quality), the operation influencing data can also contain corresponding warnings given the threat of critical states, which are also output to the user of the vehicle 1 via the display 7.

Finally, as a function of the analysis of first data, the analyzer device 2.4 takes the third monitoring response of executing a maintenance protocol for the vehicle 1 via a third monitoring response device connected with the second security module 2.2 in the form of a vehicle management device 2.7. Depending on the monitoring data, plans and preparations can here be drawn up for servicing the vehicle 1 upon its return. In particular, necessary replacement parts or the like can already be ordered in advance to minimize the time necessary for maintenance, and hence reduce down times for the vehicle 1.

The acquisition devices 4 and 5, the first security module 1.2 and the first mobile radio module 1.1 are arranged in a secure environment 1.3 safeguarded against unauthorized access, so as to effectively preclude unauthorized access not just to the data of the security module one of second but also to the data supplied by and to the acquisition devices 4 and 5 or to the first mobile radio module 1.1.

The secure environment 1.3 is physically established by secure housings of the acquisition devices 4 and 5, the mobile radio module 1.1 and the first security module 1.2, which are equipped with sufficiently known means for detecting manipulations on the housing. Additionally, it is logically established using a secured communication protocol between these components. During each communication between the components, via a correspondingly strong mutual authentication, a secured communication channel is built up. It is understood that the components have corresponding communication means to this end, which provide the described security functionalities.

However, it is understood that none or only several of the mentioned components can be arranged in a corresponding secure environment in other variants of the invention, depending on the security requirements to be imposed.

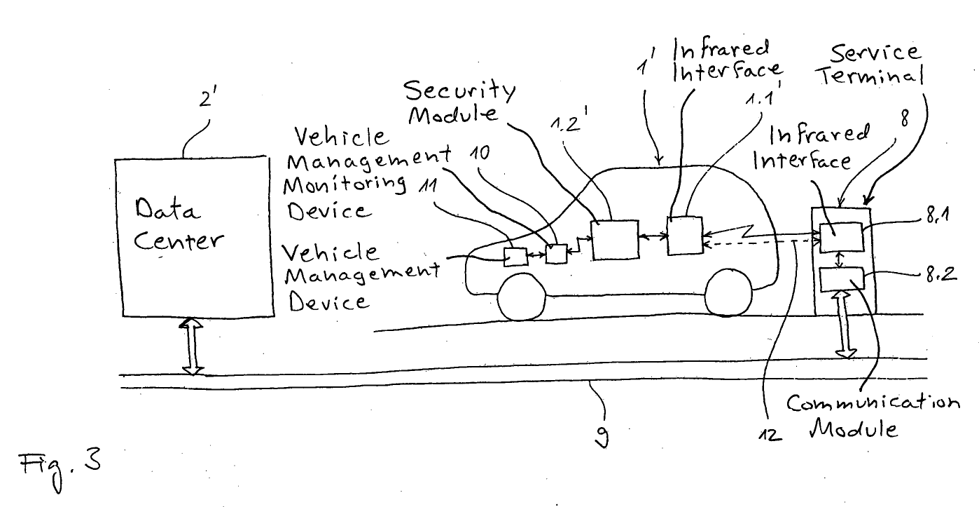

FIG. 3 shows another preferred exemplary embodiment of the arrangement according to the invention, the basic functioning of which is similar to that described on FIG. 1, so that only the difference will be mentioned.

One difference is that the first transmitter device of the vehicle 1′ connected with the first security module 1.2′ is a short-range first infrared interface 1.1′. The infrared interface 1.1′ here operates according to the IrDA standard. However, it is understood that an arbitrary other transmission processes with a short range, e.g., Bluetooth, etc., can be used in other embodiments of the invention.

The second transmitter device consists of a service terminal 8. This service terminal 8 has a corresponding second infrared interface 8.1 and a communication module 8.2 connected thereto, which transmits the first data received from the second infrared interface 8.1 to the data center 2′ via a telecommunications network 9.

The security relevant first data are generated, authenticated, transmitted and logged from the vehicle 1′ to the data center 2′ and vice versa similar to the embodiment described in conjunction with FIG. 1 above, so that reference will only be made to the above statements.

Another difference is that the first security module 1.2′ is connected with a vehicle management monitoring device 10, which is in turn connected with the vehicle management device 11 of the vehicle 1′. The vehicle management device 11 here represents the device that controls the functions of the individual components of the vehicle. In particular, it comprises motor management, etc.

Among other things, the vehicle management monitoring device 10 in this case monitors the function of the software components of the vehicle management device 11 as a third acquisition device. The data acquired by the vehicle management monitoring device 10 are incorporated into a first data set in the manner described above as third acquisition values, and hence as monitoring data, authenticated and transmitted to the data center 2′.

Depending on the analysis of the transmitted monitoring data in the data center 2′, the data center 2′ generates, authenticates and sends corresponding operation influencing data to the vehicle 1′ in the manner described above via the service terminal 8. During the analysis of the monitoring data, the data center 2′ not just checks the integrity of the vehicle management device 11. Among other things, it also checks the current version of the software modules used by the vehicle management device 11. If a new version exists for one of the software modules, it is transmitted to the vehicle 1′ as a constituent of the operation influencing data.

After the first security module 1.2′ has verified the authenticity of the operation influencing data in the manner described above, it passes along the operation influencing data, in particular the new software module, to the vehicle management monitoring device 10. This vehicle management monitoring device 10 simultaneously represents an operation influencing device by controlling the replacement of the now obsolete, old software module by the new software module in the vehicle management device 11.

The transmission of operation influencing data from the data center 2′ to the vehicle 1 is also logged in the manner described above. In this case, an identification of the service terminal 8 is also introduced as the source identification in the corresponding first data set, so that transmission via this service terminal 8 can be retraced without any doubt at a later point.

In particular, the identification of the first security module 1.2′ is used as a receiver identification in the first data set of the protocol data set. In cases where the replacement of the respective software module costs money, this can later be used as verification that the software module was actually received in the vehicle 1′. If necessary, a corresponding exchange confirmation can be introduced in the first data set to also make the actual exchange retraceable without any doubt.

It is understood that, in such cases involving a cost-liable servicing of the vehicle software or given other cost-liable operation influences, a corresponding invoicing process can be initiated in the data center with receipt of a corresponding receipt confirmation from the vehicle 1′.

Communication between the motor vehicle 1′ and the data center 2′ proceeds like the communication process described above in conjunction with FIG. 1. In particular, a strong mutual authentication takes place using cryptographic means, thereby always ensuring that only authorized and authentic data are exchanged and used in conjunction with the authentication of the first data.

The described exemplary embodiment makes it possible to realize an area-wide network of service terminals 8, which enable a simple monitoring and remote servicing of vehicles.

The embodiment was described above based on a wireless connection to the service terminal 8. However, it is understood that other embodiments can use a wired connection to the service terminal, as denoted on FIG. 3 by the arrow 12. For example, a data cable can be used, connecting the motor vehicle with a second transmitter device of the service terminal via corresponding serial interfaces.

In addition, it is understood that other embodiments of the invention can use a mobile device as the service terminal, which then establishes a connection to the data center via mobile radio network or the like, if needed. Such an embodiment of the invention is particularly well suited for use in conjunction with breakdown services or the like.

Finally, it is understood that the first security module does not necessarily have to be a component of the mobile unit. In conjunction with the already mentioned service terminal, in particular the mobile service terminal, it is possible to integrate the first security module or parts thereof, e.g., the cryptography module, in a service terminal. The mobile device, in addition to the acquisition devices and a corresponding interface for connection with the service terminal, may have only the first protocol memory in which the protocol data set is written by the service terminal.

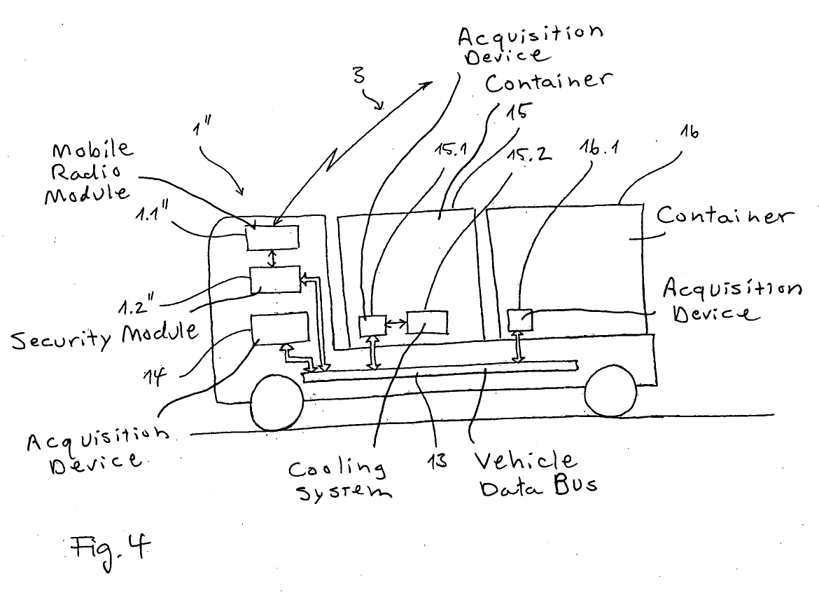

FIG. 4 shows another preferred exemplary embodiment of the arrangement according to the invention, the basic functioning of which is similar to FIG. 1, so that only the differences will be mentioned.

One difference lies in the fact that the first security module 1.2″ of a truck as the first vehicle 1″ is connected by a vehicle data bus 13 not just with an acquisition device 14 of the vehicle 1″ via which the state data of the vehicle are determined, including its position. Rather, the first security module 1.2″ is also connected with an acquisition device 15.1 of a loaded first container 15 and an acquisition device 16.1 of a loaded second container 16. The acquisition devices 15.1 and 16.1 are used to determine respective state data of the container 15 and 16 and its load.

In this case, the vehicle data bus 13 involves a wireless data bus. However, it is understood that a wired data bus can also be used in other embodiments of this invention.

The acquisition values of the acquisition devices 14, 15.1 and 16.1 are transmitted to the first security module 1.2″, and then transmitted in the manner described above in conjunction with FIG. 1 to a remote data center (not shown) via a first mobile radio module connected with the first security module 1.2″.

This makes it possible not just to monitor and, if necessary, influence the state of the motor vehicle 1″. Rather, a single security module 1.2″ also makes it possible to monitor the state of the load in the vehicle 1″, and influence it as needed. For example, if the container 15 is a refrigeration container, and a rise in the temperature exceeding a prescribed limit is detected in the container 15 via the acquisition device, operation can be influenced via the data center in the manner described above. To this end, for example, the refrigerating capacity of the cooling system 15.2 of the container 15 can be increased via the corresponding operation influencing data transmitted from the data center. In addition, the stored protocol data sets authenticated in the manner described above can be used to verify the temperature progression inside the container 15 without any doubt, if required. This can be used when transporting perishable foods, such as meat or the like, to verify that the temperature of the foods always remained below prescribed limits for the time stored inside the container 15.

In addition, determining the position of the motor vehicle 1″ with the acquisition device 14 makes it possible in particular to reproduce the location of the containers 15 and 16. In particular, this data can be incorporated into a superordinate logistical planning process.

The position can be determined by the acquisition device 14 in any known manner. For example, the acquisition device 14 can be a corresponding GPS module. However, the position can also be determined via the mobile radio network 3″ in a known manner.

It should be noted as well that communication between the vehicle 1″ and the data center proceeds like the communication process described above in conjunction with FIG. 1. In particular, a strong mutual authentication takes place using cryptographic means, thereby always ensuring, in conjunction with the authentication of the first data, that only authorized and authentic data are exchanged and used.

This invention was described above exclusively on the basis of examples for vehicles. However, it is understood that the invention can also be used in conjunction with any other moving devices, e.g., containers, etc.

Although modifications and changes may be suggested by those skilled in the art, it is the invention of the inventors to embody within the patent warranted heron all changes and modifications as reasonably and properly come within the scope of their contribution to the art.

I claim as my invention:

1. (canceled)

2-37. (canceled)

38. (A method for transmitting data between a mobile device and a data center remote from said mobile device, comprising the steps of:
generating cryptographically authenticated data at a mobile device; and
transmitting the cryptographically authenticated data from a transmitter device at said mobile device.

39. A method as claimed in claim 38 wherein said mobile device comprises a source for said data and wherein said data center comprises a receiver that receives the data transmitted from said transmitter device, and wherein the step of cryptographically authenticating said data comprises including an identification in said data selected from the group consisting of an identification of said source, an identification of said receiver, and a transmission identification.

40. A method as claimed in claim 38 comprising including in said data at least one time code characteristic for a specifiable event.

41. A method as claimed in claim 38 comprising incorporating said data into a protocol data set, and storing said protocol data set in at least one of said transmitter device and said data center.

42. A method as claimed in claim 38 wherein the step of cryptographically authenticating said data comprises authenticating said data using at least one digital signature.

43. A method as claimed in claim 38 comprising with an acquisition device at said mobile device, acquiring an acquisition value relating to operation to said mobile device, and including said acquisition value in said data that are transmitted by said transmitter device.

44. A method as claimed in claim 43 comprising acquiring said acquisition value as an acquisition variable representing a state variable of the operation of said mobile device.

45. A method as claimed in claim 43 wherein said mobile device comprises an operation influencing device that influences said operation of said mobile device, and comprising, at said data center, generating operating influencing data dependent on said acquisition variable and transmitting said operation influencing data from said data center to said mobile device, and controlling said operation influencing device at said mobile device using said operation influencing data.

46. A method as claimed in claim 45 comprising, at said data center before generating said operation influencing data, verifying said data transmitted from said mobile device and, only after a successful verification thereof, generating said operation influencing data at said data center.

47. A method as claimed in claim 45 comprising, at said data center, initiating a response to generating said operation influencing data.

48. A method as claimed in claim 47 comprising initiating an invoicing procedure as said response.

49. A method as claimed in claim 45 comprising making additional data available at said data center, not transmitted from said mobile device, and generating said operation influencing data at said data center dependent on said acquisition value and said additional data.

50. An arrangement for transmitting data between a mobile device and a data center remote from said mobile device, comprising the steps of:
an encrypter that generates cryptographically authenticated data at a mobile device; and
a transmitter that transmits the cryptographically authenticated data from a transmitter device at said mobile device.

51. An arrangement as claimed in claim 50 wherein said mobile device comprises a source for said data and wherein said data center comprises a receiver that receives the data transmitted from said transmitter device, and wherein said encrypter cryptographically authenticates said data by including an identification in said data selected from the group consisting of an identification of said source, an identification of said receiver, and a transmission identification.

52. An arrangement as claimed in claim 50 wherein said encrypter includes in said data at least one time code characteristic for a specifiable event.

53. An arrangement as claimed in claim 50 wherein said encrypter incorporates said data into a protocol data set, and comprising a memory in which said protocol data set are stored at at least one of said transmitter device and said data center.

54. An arrangement as claimed in claim 50 wherein said encrypter cryptographically authenticates said data by authenticating said data using at least one digital signature.

55. An arrangement as claimed in claim 50 comprising with an acquisition device at said mobile device that acquires an acquisition value relating to operation to said mobile device, and wherein said encrypter includes said acquisition value in said data that are transmitted by said transmitter device.

56. An arrangement as claimed in claim 55 wherein said encrypter acquires said acquisition value as an acquisition variable representing a state variable of the operation of said mobile device.

57. An arrangement as claimed in claim 55 wherein said mobile device comprises an operation influencing device that influences said operation of said mobile device, and comprising, at said data center, a processor that generate operating influencing data dependent on said acquisition variable and a transmitter that said operation influencing data from said data center to said mobile device, and a controller that controls said operation influencing device at said mobile device using said operation influencing data.

58. An arrangement as claimed in claim 57 comprising, a verification unit at said data center that, before generation of said operation influencing data, verifies said data transmitted from said mobile device and only after a successful verification thereof, permits generation of said operation influencing data at said data center.

59. An arrangement as claimed in claim 57 wherein said processor, at said data center initiates a response to generating said operation influencing data.

60. An arrangement as claimed in claim 57 wherein said processor initiates an invoicing procedure as said response.

61. An arrangement as claimed in claim 57 wherein said processor has access to additional data available at said data center, not transmitted from said mobile device, and generates said operation influencing data at said data center dependent on said acquisition value and said additional data.
